(19) United States
(12) Patent Application Publication
(10) Pub. No.: US 2007/0211585 A1
(43) Pub. Date: Sep. 13, 2007

(54) System and method of adjusting channel properties for optical storage systems

(75) Inventor: Sheng-hung Wu, Hsinchu (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: CHEERTEK INC.

(21) Appl. No.: 11/446,387

(22) Filed: Jun. 5, 2006

(30) Foreign Application Priority Data
Mar. 8, 2006 (TW) 095107738

(51) Int. Cl. G11B 7/00

(52) U.S. Cl. 369/44.29; 369/44.27; 369/59.1

(57) ABSTRACT

A method of adjusting channel properties of an optical storage system is disclosed to include the steps: Step 1) give a modify step, a trial step and a threshold, Step 2) give an initial point, Step 3) add an initial focus point to the trial step and measure the sum so as to obtain a first jitter value, Step 4) deduct the trial step from the initial focus point and measure the difference so as to obtain a second jitter value, Step 5) deduct the second jitter value from the first jitter value and judge if the difference is greater than the threshold or not, Step 6) deduct the modify step from the initial focus point and then return to step 3) when the difference obtained from step 5) is greater than the threshold, Step 7) deduct the first jitter value from the second jitter value and judge if the difference is greater than the threshold or not in case the difference obtained from step 5) is smaller than the threshold, Step 8) add the initial focus point to the modify step and then return to step 3) when the difference obtained from step 7) is greater than the threshold, and Step 9) keep the initial focus point and return to step 3) to continue search if the difference obtained from step 7) is smaller than the threshold.

### BACKGROUND OF THE INVENTION

1. Field of the Invention

The present invention relates an optical storage system and more particularly, to a channel property adjustable optical storage system, which searches the optimal focus point quickly when the read-write head is defocusing, which optimal focus point having the least jitter value and a relatively higher sensitivity. The invention relates also to the method of adjusting channel properties of the optical storage system.

2. Description of the Related Art

In regular optical storage systems, such as CD or DVD systems, jitter error is one of the standard evaluation items when evaluating the performance of the servo, i.e., the lower the jitter error is the better the servo control target point will be. On the contrary, the higher the jitter error is the poorer the servo control target point will be. Therefore, the way to lower system jitter error has a great concern with the selection of the optimal servo control target point in the optical storage system.

A prior art analog jitter error rate evaluation method is known in U.S. Pat. No. 6,353,585, filed on Aug. 20, 1997, issued on Mar. 5, 2003, entitled “Apparatus and method of forming evaluation signal used in adjusting focus bias and adjusting skew of disk drive”, in which phase error information between a phase of a read data signal and a phase of a clock signal formed in synchronism with the read data signal, is detected, the phase error signal is converted into an analog signal and is outputted as an evaluation signal having a signal level in accordance with the phase error amount and the evaluation signal is inputted after A/D conversion to a portion for carrying out signal quality evaluation by using the evaluation signal whereby pertinent signal evaluation can be carried out by a simple constitution. According to this method, the servo must create a different when measuring the hitter value, and counting can be started only after EFM occurred, therefore offset tends to occur. Further, the drift problem may occur when the clock signal is not 50% work cycle.

Further, in the U curve that is commonly used to evaluate jitter error, the optimal focus point corresponds to the least jitter error rate and data error rate. According to the optical reader in U.S. application 2005/0254358A1, filed on Apr. 9, 2003 and issued on Nov. 17, 2005, the method of trial and error is employed to search the optimal focus point, in which n points are picked up from the bottom of the U curve, and then the average of the selected points is obtained for determining the optimal focus point. However, because the bottom of the U curve is very flat such that it is a little hard and slow to find out the rear bottom point.

### SUMMARY OF THE INVENTION

The present invention has been accomplished under the circumstances in view. It is the main object of the present invention to provide a channel property adjustable optical storage system, which searches the optimal focus point quickly by utilizing the steeper slope a little far aside from the real bottom point with the U curve symmetry assumption.

It is another object of the present invention to provide a channel property adjustable optical storage system, which searches the optimal focus point quickly by comparing one or a number of the setting parameters of optical focus error, tracking error and tilt error.

It is still another object of the present invention to provide a channel property adjustable optical storage system, which comprises a jitter measuring unit and a jitter servo control unit. The jitter measuring unit uses the unbiased jitter histogram to obtain a jitter value, for enabling the jitter servo control unit to quickly decide the optimal focus point subject to the jitter value.

It is still another object of the present invention to provide a method of correcting the settings of the servo and RF signal of an optical storage system, which allows the biased jitter value to be classified as a NT-based jitter value or a NT-MT based jitter value with that the NT-based biased jitter value has a statistic on the RF width only or that the NT-MT-based biased jitter value has a statistic on different adjacent NT-MT and high-low combinations. Both (NT-based biased jitter value and the NT-MT-based biased jitter value) can be employed to the biased jitter histogram to deduct the statistic center so as to obtain an unbiased jitter histogram.

To achieve the aforesaid objects, the method of adjusting channel properties of the optical storage system in accordance with the present invention comprises the steps: 1) give a modify step, a trial step and a threshold, 2) give an initial point, 3) add an initial focus point to the trial step and measure the sum so as to obtain a first jitter value, 4) deduct the trial step from the initial focus point and measure the difference so as to obtain a second jitter value, 5) deduct the second jitter value from the first jitter value and judge if the difference is greater than the threshold or not, 6) deduct the modify step from the initial focus point and then return to step 3) when the difference obtained from step 5) is greater than the threshold, 7) deduct the first jitter value from the second jitter value and judge if the difference is greater than the threshold or not in case the difference obtained from step 5) is smaller than the threshold, 8) add the initial focus point to the modify step and then return to step 3) when the difference obtained from step 7) is greater than the threshold, and 9) keep the initial focus point and return to step 3) to continue search if the difference obtained from step 7) is smaller than the threshold.

To achieve the aforesaid objects, the channel property adjustable optical storage system of the present invention comprises at least: a RF (radio frequency) filter adapted to receive a RF (radio frequency) signal outputted from an optical detector of the optical storage system, a phase-lock-loop coupled to the RF filter and adapted to receive the RF signal and to output a corresponding phase signal, a jitter measuring unit respectively coupled to the RF filter and the phase-lock-loop and adapted to obtain a phase difference subject to the phase signal and the RF signal and then to obtain a jitter value subject to the phase difference, and a jitter servo control unit coupled to the jitter measuring unit and adapted to make a servo control subject to the jitter value.

To achieve the aforesaid objects, the method of correcting the settings of the servo and RF signal of the optical storage system in accordance with the present invention comprises the steps of: 1) compare a RF signal to the recovery time pulse thereof to obtain a phase difference signal, 2) convert the phase difference signal into a bias jitter value, 3) count the number of the biased jitter value falling to every pit width of the RF signal so as to obtain a biased jitter histogram having the center thereof based on the center of the statistic center, 4) deduct the statistic center to obtain an unbiased jitter histogram, and 5) send the unbiased jitter histogram to a servo for search so as to obtain a lower jitter value and a better focus point.

### BRIEF DESCRIPTION OF THE DRAWINGS

FIG. 1 is a system block diagram of an optical storage system in accordance with the present invention.

FIG. 2 is a schematic drawing showing a high frequency boot around the cut-off frequency obtained through the low pass filter of the optical storage system according to the present invention.

FIG. 3 illustrates the jitter error defined as the phase error norm.

FIG. 4a is a biased jitter histogram according to the present invention.

FIG. 4b is an unbiased jitter histogram according to the present invention.

FIG. 5 is a flow chart showing the channel properties adjustment operation of the jitter servo control unit JSCU according to the present invention.

FIG. 6 is a U curve obtained from the channel properties adjustment operation of the jitter servo control unit JSCU according to the present invention.

FIG. 7 is a flow chart illustrating the correction of the settings of the servo and RF signal of an optical storage system according to the present invention.

Table 1 illustrates a more efficient simultaneous search example of the jitter servo control unit on focus error, tracking error, and tilt error.

### DETAILED DESCRIPTION OF THE INVENTION

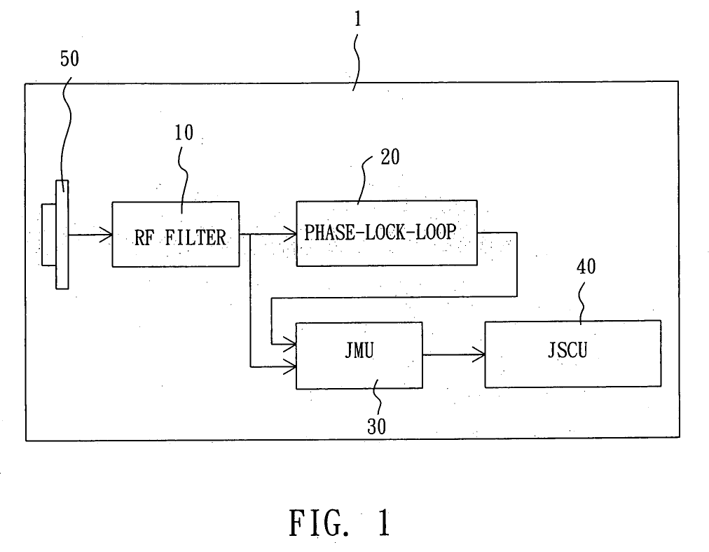

Referring to FIG. 1, an optical storage system 1 with adjustable channel properties in accordance with the present invention is shown comprising an RF (radio frequency) filter 10, a phase-lock-loop PLL 20, a jitter measuring unit JMU 30, and a jitter servo control unit JSCU 40.

The RF filter 10 is preferably a low pass filter LPF that receives RF signals outputted from the photo detector 50 of the optical storage system 1 and removes high frequency noises. The low pass filter LPF is designed to have adjustable cut-off frequency and the inherited high frequency boost. The low pass filter LPF can filter out high frequency noises and the boost can compensate some inner symbol interferences (ISI) of the RF pattern. The value of the boost is determined subject to the jitter value.

The phase-lock-loop PLL 20 is coupled to the RF filter 10 to receive the RF signal and to output a phase signal to the jitter measuring unit JMU 30 for measuring the jitter value of the RF signal. Because the phase-lock-loop PLL 20 is similar to the phase-locked loop of a regular optical storage system, no further detailed description in this regard is necessary.

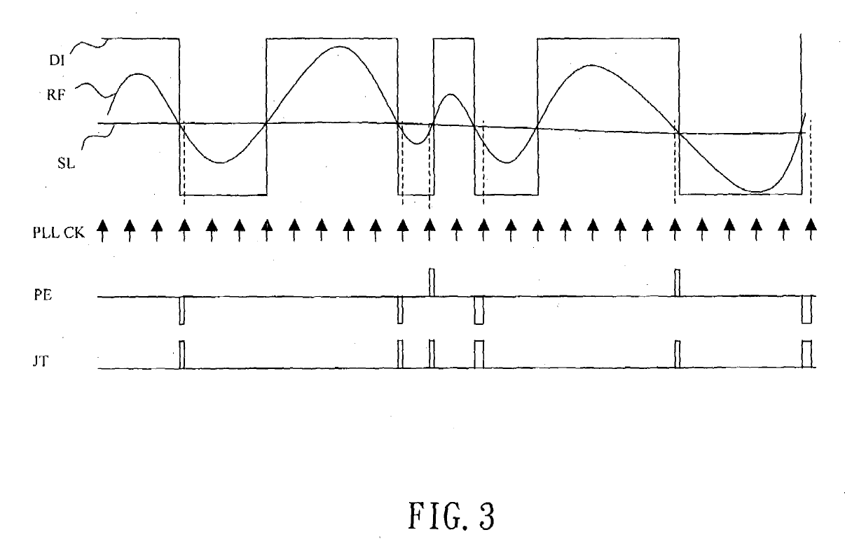

The jitter measuring unit JMU 30 is respectively coupled to the RF filter 10 and the phase-lock-loop PLL 20, and adapted to compare the phase difference between the phase signal and the RF signal and to further obtain the jitter value subject to the phase difference. With respect to the detailed operation principle of the jitter measuring unit JMU 30, please refer to the description of FIG. 3.

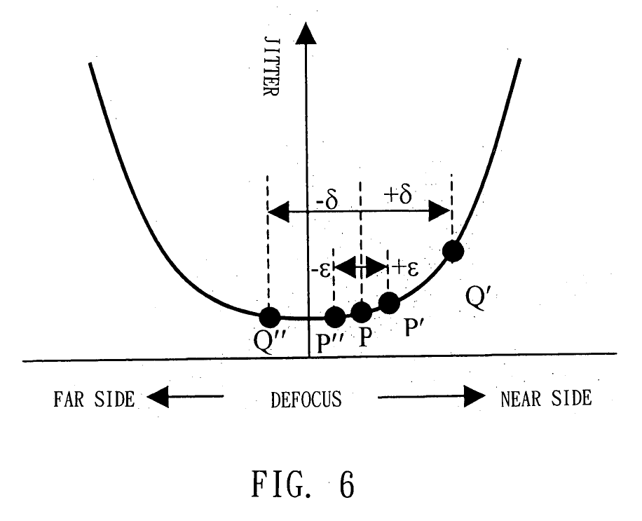

The jitter servo control unit JSCU 40 is coupled to the jitter measuring unit JMU 30, and adapted to control the servo (not shown) subject to the jitter value measured by the jitter measuring unit JMU 30. With respect to the control method of the jitter servo control unit JSCU 40, please refer to the description of FIG. 5.

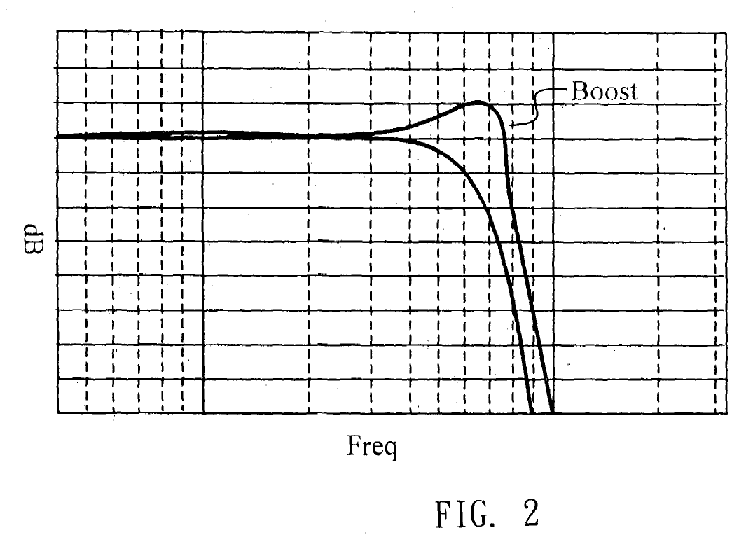

Referring to FIG. 2, a regular disk has data of different lengths, for example, 3 T˜14 T pit width on the groove. The photo detector 50 detects the data, so that the photo detector 50 provides the RF signals. However, the RF signals may have crosstalk that may make the RF signal of a particular length, for example but not limited to 3 T, become smaller. As indicated in FIG. 2, the low-pass filter LPF 10 removes high frequency noises from the RF signal around 3 T, and has adjustable cut-off frequency and the inherited high frequency boost. Therefore, the low-pass filter LPF 10 can filter out high frequency noises and the boost can compensate some inner symbol interferences (ISI) of the RF pattern. The boost value is determined subject to the jitter value. The adjustment is made in direction toward reducing the jitter value.

Referring to FIG. 3, the analog signal RF is sliced with the slice level SL and digitized as the DI signal. A phase difference PE between the phase-lock-loop clock PLL CK and the DI is measured by the jitter measuring unit JMU 30 and taken the norm as RF jitter JT. As illustrated, when the PLL CK goes in front of the DI signal, a positive phase difference PE is obtained. On the contrary, when the PLL CK goes behind the DI signal, a negative phase difference PE is obtained. The jitter measuring unit JMU 30 measures the RF jitter JT by means of digitalization, thereby improving the drawback of the prior art RF jitter JT analog measuring method being not able for a delay comparison.

The phase difference signal PE has a signed value. The jitter measuring unit JMU 30 can use 1-norm, 2-norm or the infinite norm of a window to obtain the positive jitter value JT. The 1-norm is to make an absolute value calculation on the symbolized phase difference signal PE, so as to obtain a positive jitter value JT. The 2-norm is to make an extraction of square calculation on the symbolized phase difference signal PE, so as to obtain a positive jitter value JT. The infinite norm of a window is to pick up the maximum absolute value within a time window (for example, pick up 20 absolute values), so as to obtain a positive jitter value JT.

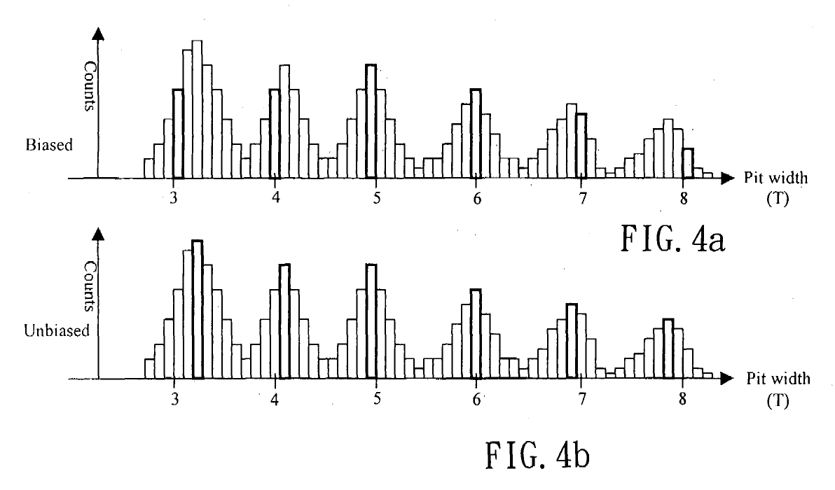

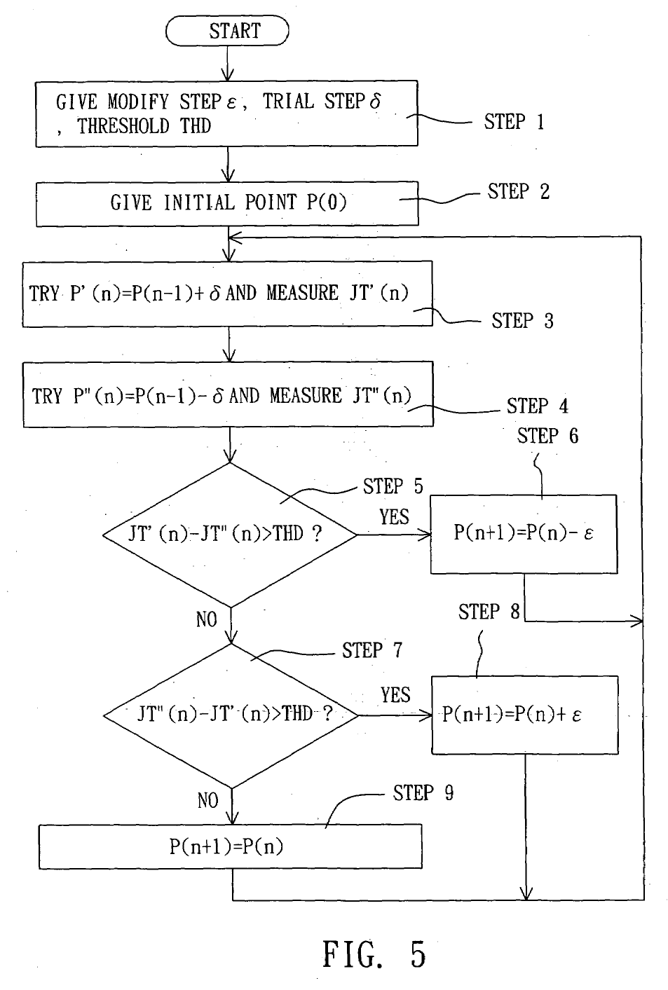

FIGS. 4a and 4b are biased and unbiased jitter histograms measured through the jitter measuring unit JMU 30. A compact disk (not shown) carries a big number of signals of lengths within 3 T˜11 T. These signals of pit with within 3 T-11 T are collected and arranged in a non-classified manner, and the biased jitter histogram shown in FIG. 4a is thus obtained. This biased jitter histogram is based on the center of the integral number T of PLL.

As shown in FIG. 4a, the transverse axis is the pit width, and the longitudinal axis is the counts. The bolded portions are the respective statistic center of each pit width. There are listed statistic centers 3 T, 4 T, 5 T, 6 T, 7 T & 8 T. Those over 8 T are not shown in the drawing. The bars of the jitter values JT beyond the statistic centers are the jitter value error counting, here is called the biased jitter histogram.

However, when molding or programming the optical disc, the biased jitter value has been decided and is not controllable by the jitter servo control unit JSCU 40. Therefore, it is not an ideal method to evaluate jitter error by means of the biased jitter histogram. The jitter measuring unit JMU 30 deducts the statistic centers from the biased jitter histogram of FIG. 4a, thereby obtaining the unbiased jitter histogram of FIG. 4b. This unbiased jitter histogram is sent to the jitter servo control unit 40 for search, thereby obtaining the least jitter value and the optimal focus point.

The jitter bias can be classified as NT-based or NT-MT-based with that the former has a statistic on the RF width only or that the later has a statistic on different adjacent NT-MT and high-low combinations. For example, one can measure the average 3 T width as illustrated in FIG. 4a. Or one can measure the average phase error between adjacent high-3 T and low-5 T sequence or the average phase error between adjacent low-3 T and high-5 T sequence. This jitter bias can be real-time measured and utilized simultaneously or off-time measured and recorded then locked-up as a pre-determined table for inquiry. In this pre-determined table, the RF filter 10 recorded the different relationship between 3 T radio frequency signal and the other radio frequency signals 4 T, 5 T, 6 T, 7 T & 8 T.

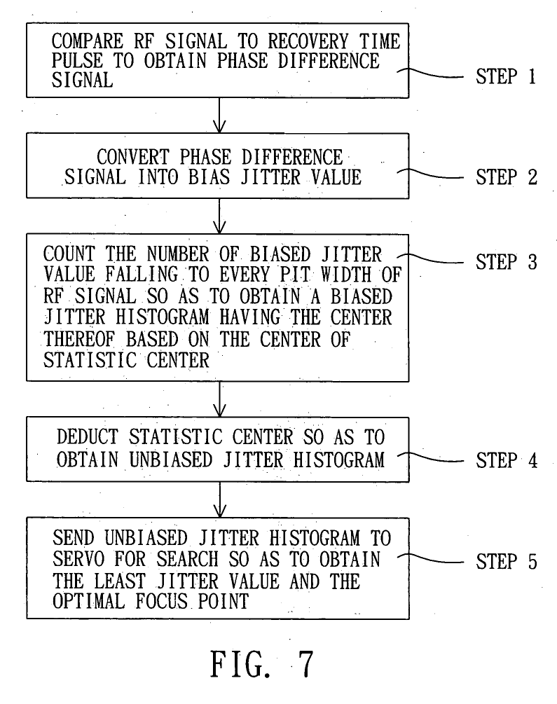

FIG. 5 is a flow chart showing the channel properties adjustment operation of the jitter servo control unit JSCU 40. FIG. 6 is a U curve obtained from the channel properties adjustment operation of the jitter servo control unit JSCU 40. The jitter servo control unit JSCU 40 can adjust the channel properties of the optical storage system 1, so that the read-write head search the optimal focus point from the system control variables when defocusing. The optimal focus point has the least jitter value and better sensitivity. The channel properties adjustment method includes the steps of give a modify step ε, a trial step δ and a threshold THD (Step 1); give an initial point P(0) (Step 2); add an initial focus point P(n) to the trial step δ and measure the sum so as to obtain a first jitter value JT′(n) (Step 3); deduct the trial step δ from the initial focus point P(n) and measure the difference so as to obtain a second jitter value JT″(n) (Step 4); deduct the second jitter value JT″(n) from the first jitter value JT′(n) and judge if the difference is greater than the threshold THD or not (Step 5); deduct the modify step ε from the initial focus point and then return to Step 3 when the result is greater than the threshold THD (Step 6); deduct the first jitter value JT′(n) from the second jitter value JT″(n) and judge if the difference is greater than the threshold THD or not in case the judgment in Step 5 is negative (Step 7); add the initial focus point to the modify step ε and then return to Step 3 when the difference obtained from the calculation in Step 7 is greater than the threshold THD (Step 8); keep the initial focus point and return to Step 3 if the difference obtained from the calculation in Step 7 is smaller than the threshold THD (Step 9). This aforesaid procedure is repeated again and again until the optimal focus point is obtained.

The aforesaid Step 1 is to give a modify step ε, a trial step δ and a threshold THD, in which the trial step δ is greater than the modify step ε; the threshold THD is to protect trial and sear steps against noises and interferences, preventing a drift.

The aforesaid Step 3 is to add an initial focus point P(n) to the trial step δ and to measure the sum so as to obtain a first jitter value JT′(n). The mathematical equation is: P′(n)=P(n−1)+δ, thereby obtaining Q′ as shown in FIG. 6.

The aforesaid Step 4 is to deduct the trial step 6 from the initial focus point P(n) and measure the difference so as to obtain a second jitter value JT″(n). The mathematical equation is: P″(n)=P(n−1)−δ, thereby obtaining Q″ as shown in FIG. 6. When measuring the first jitter value JT′(n) and the second jitter value JT″(n), it simultaneously search at least one parameter in proper order so as to obtain the first jitter value JT′(n) and the second jitter value JT″(n) rapidly. The parameter can be a focus error, tracking error, or tilt error.

Table 1 illustrates a more efficient simultaneous search example where only one setting is changed at one time, gives total 6 comparisons per revolution and the trial and comparison rate is 1. A higher the trial and comparison ration gives a higher rate of convergence.

The aforesaid Step 5 is to deduct the second jitter value JT″(n) from the first jitter value JT′(n) and judge if the difference is greater than the threshold THD or not. The mathematical equation is: JT′(n)−JT″(n)>THD? If the difference is greater than the threshold THD, it means the slope of the right side of the U curve is steeper than the slope of the left side of the U curve. In this case, the mid value of the right side of the U curve is picked up and the procedure proceeds, i.e., it proceeds to Step 6. If the difference is smaller than the threshold THD, it means the slope of the left side of the U curve is steeper than the slope of the right side of the U curve. In this case, the mid value of the left side of the U curve is picked up and the procedure proceeds, i.e., it proceeds to Step 6.

The aforesaid step 6 is to deduct the modify step ε from the initial focus point and then return to Step 3 to continue the search. The mathematical equation is:

P(n+1)=P(n)−ε.

The aforesaid Step 7 is to deduct the first jitter value JT′(n) from the second jitter value JT″(n) of which the mathematical equation is: JT″(n)−JT′(n)>THD?.

The aforesaid Step 8 is to add the initial focus point to the modify step ε and then return to Step 3 to continue the search. The mathematic equation of this step is:

P(n+1)=P(n)+ε.

The aforesaid Step 9 is to keep the initial focus point and then to return to Step 3 to continue the search until appearance of the optimal focus point.

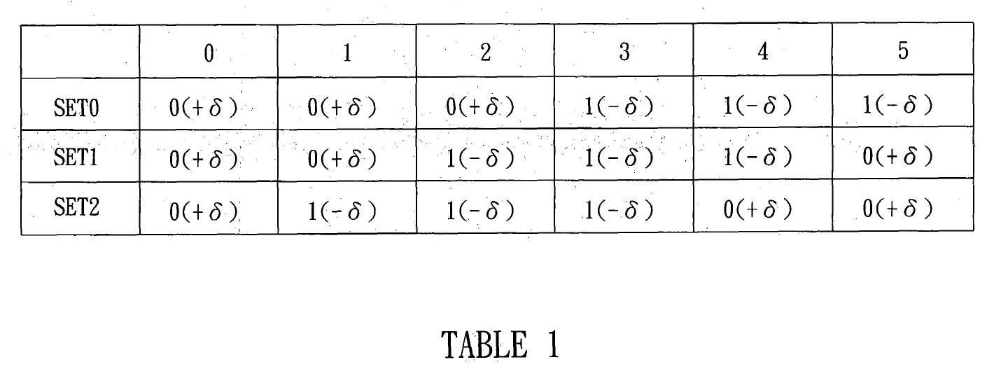

Further, the invention also provides a servo and RF signal setting calibration method for the optical storage system. FIG. 7 is a flow chart illustrating the correction of the settings of the servo and RF signal of the optical storage system. This setting correction method includes the steps of: compare a RF signal to its recovery time pulse to obtain a phase difference signal (Step 1); convert the phase difference signal into a bias jitter value (Step 2); count the number of the biased jitter value falling to every pit width of the RF signal so as to obtain a biased jitter histogram having the center thereof based on the center of the statistic center (Step 3); deduct the statistic center so as to obtain an unbiased jitter histogram (Step 4); and send the unbiased jitter histogram to a servo for search so as to obtain the least jitter value and the optimal focus point (Step 5).

With respect to the description related to the aforesaid Steps 1˜5, please refer to the description of FIGS. 3 and 4.

Therefore, according to the aforesaid system and method of adjusting channel properties for optical storage systems, the jitter measuring unit uses the unbiased jitter histogram to obtain a jitter value, for enabling the jitter servo control unit to quickly decide the optimal focus point subject to the jitter value. Further, an improvement can be made through the jitter servo control unit by utilizing the steeper slope a little far aside from the real bottom point with the U curve symmetry assumption. Therefore, the jitter servo control unit can quickly search the optimal focus point, i.e., the invention improves the drawbacks of the prior art optical storage systems.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method of adjusting channel properties of an optical storage system for enabling the read-write head of the optical storage system to search from control variables of the optical storage system the optimal focus point that has the least jitter value and high sensitivity, the method comprising the steps:
Step 1) give a modify step, a trial step and a threshold;
Step 2) give an initial point;
Step 3) add an initial focus point to said trial step and measure the sum so as to obtain a first jitter value;
Step 4) deduct the trial step from the initial focus point and measure the difference so as to obtain a second jitter value;
Step 5) deduct said second jitter value from said first jitter value and judge if the difference is greater than said threshold THD or not;
Step 6) deduct said modify step from said initial focus point and then return to Step 3) when the difference obtained from step 5) is greater than said threshold;
Step 7) deduct said first jitter value from said second jitter value and judge if the difference is greater than said threshold THD or not in case the difference obtained from step 5) is smaller than said threshold;
Step 8) add said initial focus point to said modify step and then return to step 3) when the difference obtained from step 7) is greater than said threshold;
Step 9) keep said initial focus point and return to step 3) to continue search if the difference obtained from step 7) is smaller than said threshold.

2. The method as claimed in claim 1, wherein said trial step is greater than said modify step.

3. The method as claimed in claim 1, wherein said threshold is to protect trial and error steps against noises and interferences, preventing a drift.

4. The method as claimed in claim 1, wherein when measuring said first jitter value and said second jitter value, the method searches at least one parameter in proper order on the same time so as to quickly obtain said first jitter value and said second jitter value.

5. The method as claimed in claim 4, wherein said at least one parameter includes at least one of the focus error, tracking error and tilt error.

6. A channel property adjustable optical storage system comprising at least:
a RF (radio frequency) filter adapted to receive a RF (radio frequency) signal outputted from an optical detector of the optical storage system;
a phase-lock-loop coupled to said RF filter and adapted to receive said RF signal and to output a corresponding phase signal;
a jitter measuring unit respectively coupled to said RF filter and said phase-lock-loop and adapted to obtain a phase difference subject to said phase signal and said RF signal and then to obtain a jitter value subject to said phase difference; and
a jitter servo control unit coupled to said jitter measuring unit and adapted to make a servo control subject to said jitter value.

7. The channel property adjustable optical storage system as claimed in claim 6, wherein said RF filter is a low pass filter.

8. The channel property adjustable optical storage system as claimed in claim 6, wherein said low pass filter is adapted to filter out high frequency noises, to obtain a high boost around the cutoff frequency for compensating inner symbol interferences (ISI) of said RF signal, said boost being determined subject to said jitter value.

9. The channel property adjustable optical storage system as claimed in claim 6, wherein said phase difference signal is a signed value; said jitter measuring unit is adapted to selectively use 1-norm, 2-norm or the infinite norm of a window to obtain the maximum absolute value from the window so as to convert said signed value into a biased jitter value.

10. The channel property adjustable optical storage system as claimed in claim 9, wherein said jitter measuring unit counts the number of the biased jitter value falling to every pit width of the RF signal so as to obtain a biased jitter histogram having the center thereof based on the center of the statistic center.

11. The channel property adjustable optical storage system as claimed in claim 10, wherein said biased jitter value is real-time measured and utilized simultaneously or off-time measured and recorded then locked-up as a pre-determined table.

12. The channel property adjustable optical storage system as claimed in claim 10, wherein said jitter measuring unit further removes said statistic center from said biased jitter histogram, thereby obtaining an unbiased jitter histogram.

13. The channel property adjustable optical storage system as claimed in claim 12, wherein said jitter servo control unit receives said unbiased jitter histogram and uses a search method to search the optimal focus point from control variables of the system, said optimal focus point having the least jitter value and a high sensitivity.

14. The channel property adjustable optical storage system as claimed in claim 13, wherein said search method comprises the steps of:
Step 1) give a modify step, a trial step and a threshold;
Step 2) give an initial point;
Step 3) add an initial focus point to said trial step and measure the sum so as to obtain a first jitter value;
Step 4) deduct the trial step from the initial focus point and measure the difference so as to obtain a second jitter value;
Step 5) deduct said second jitter value from said first jitter value and judge if the difference is greater than said threshold THD or not;
Step 6) deduct said modify step from said initial focus point and then return to Step 3) when the difference obtained from step e) is greater than said threshold;
Step 7) deduct said first jitter value from said second jitter value and judge if the difference is greater than said threshold THD or not in case the difference obtained from step 5) is smaller than said threshold;
Step 8) add said initial focus point to said modify step and then return to step 3) when the difference obtained from step 7) is greater than said threshold;
Step 9) keep said initial focus point and return to step 3) to continue search if the difference obtained from step 7) is smaller than said threshold.

15. The channel property adjustable optical storage system as claimed in claim 14, wherein said trial step is greater than said modify step.

16. The channel property adjustable optical storage system as claimed in claim 14, wherein said threshold is to protect trial and sear steps against noises and interferences, preventing a drift.

17. The channel property adjustable optical storage system as claimed in claim 14, wherein when measuring said first jitter value and said second jitter value, the method searches at least one parameter in proper order on the same time so as to quickly obtain said first jitter value and said second jitter value.

18. The channel property adjustable optical storage system as claimed in claim 17, wherein said at least one parameter includes at least one of the focus error, tracking error and tilt error.

19. A method of correcting the settings of the servo and RF signal of an optical storage system, comprising the steps of:
Step 1) compare a RF signal to the recovery time pulse thereof to obtain a phase difference signal;
Step 2) convert said phase difference signal into a bias jitter value;
Step 3) count the number of the biased jitter value falling to every pit width of said RF signal so as to obtain a biased jitter histogram having the center thereof based on the center of the statistic center;
Step 4) deduct the statistic center to obtain an unbiased jitter histogram; and
Step 5) send said unbiased jitter histogram to a servo for search so as to obtain the least jitter value and the optimal focus point.

20. The method as claimed in claim 19, wherein said biased jitter value is further classified as NT-based and NT-MT-based jitter.

21. The method as claimed in claim 20, wherein said NT-based jitter value has a statistic on the RF width only; said NT-MT-based jitter value has a statistic on different adjacent NT-MT and high-low combinations.

22. The method as claimed in claim 21, wherein said biased jitter value is measured and recorded in a statistic table for inquiry.

23. The method as claimed in claim 22, wherein said biased jitter value is real-time or off-time measured.
